(19) United States
(12) Patent Application Publication
(10) Pub. No.: US 2018/0258584 A1
(43) Pub. Date: Sep. 13, 2018

(54) HIGH DENSITY ARTIFICIAL LEATHER HAVING EXCELLENT SURFACE TOUCH AND METHOD OF MANUFACTURING THE SAME

(71) Applicants: Hyundai Motor Company, Seoul (KR); Kia Motors Corporation, Seoul (KR); BAIKSAN Co., Ltd., Siheung-si (KR)

(72) Inventors: Gun Kang, Whasung-Si (KR); Hye Min Lee, Whasung-Si (KR); Mi Jung Yun, Whasung-Si (KR); Soon Joon Jung, Whasung-Si (KR); Sung Deuk Ahn, Whasung-Si (KR); Tae Ho Hyun, Whasung-Si (KR); Jun Suk Park, Whasung-Si (KR)

(73) Assignees: Hyundai Motor Company, Seoul (KR); Kia Motors Corporation, Seoul (KR); BAIKSAN Co., Ltd., Siheung-si (KR)

(21) Appl. No.: 15/802,860

(22) Filed: Nov. 3, 2017

(30) Foreign Application Priority Data
Mar. 9, 2017 (KR) 10-2017-0030053

(51) Int. Cl. D06N 3/00; D06N 3/10; D06N 3/14; B32B 5/02; B32B 5/06; B32B 27/12; B32B 27/40; B32B 38/08

(52) U.S. Cl. CPC D06N 3/0004; D10B 2331/04; D06N 3/0077; D06N 3/0097; D06N 3/106; D06N 3/145; B32B 5/022; B32B 5/06; B32B 27/12; B32B 27/40; B32B 38/08; D06N 2203/068; D06N 2205/243; D06N 2209/1635; D06N 2211/28; D10B 2321/021; D10B 2321/022; D10B 2321/06; D10B 2321/121; D10B 2331/02; D06N 3/0011

(57) ABSTRACT

A method for manufacturing a high density artificial leather, may include (a) manufacturing a long fiber-type non-woven fabric having an areal weight of 400 to 500 g/m² and an apparent density of 0.3 to 0.6 g/cm³ by self-twist spinning a sea component polymer fiber and an island component polymer fiber; (b) shrinking the long fiber-type non-woven fabric with hot water; (c) eluting the sea component polymer fiber from the shrunken non-woven fabric by immersing the shrunken non-woven fabric in an aqueous alkaline solution; and (d) impregnating a polymer elastomer in a non-woven fabric from which the sea component polymer fiber is eluted, to manufacture a long fiber-type fine yarn non-woven fabric.

### CROSS-REFERENCE(S) TO RELATED APPLICATIONS

The present application claims priority to Korean Patent Application No. 10-2017-0030053, filed on Mar. 9, 2017, the entire contents of which is incorporated herein for all purposes by this reference.

### BACKGROUND OF THE INVENTION

### Field of the Invention

The present invention relates to a high density artificial leather having an excellent soft texture and a method of manufacturing the same. More particularly, the present invention relates to a high density artificial leather having a texture as soft as a natural leather, having excellent physical characteristics including flexibility and elasticity, and as a result, having an improved appearance by shrinking a long fiber-type non-woven fabric with hot water, eluting only a sea component polymer fiber from the shrunken non-woven fabric, and then impregnating a polymer elastomer in a non-woven fabric from which the sea component polymer fiber is removed to manufacture a high density long fiber-type fine yarn non-woven fabric, and treating a surface of the non-woven fabric, wherein a urethane adhesive layer, a polyurethane skin layer, and a wetting layer are formed sequentially on the surface of the non-woven fabric.

### Description of Related Art

Recently, artificial leathers have been widely used in a plurality of fields including clothing, sports industries, and automobile internals due to a lightness, ease in handling, and the like thereof. However, general artificial leathers have a stiff and dry texture as compared to a natural leather, and has a problem in that the dimensional stability of the artificial leather deteriorates, fibers are frayed and/or removed by an external impact, and the like.

To solve the above problem in the related art, a leather has been manufactured using a method for introducing a limestone dispersant and limestone to humidify the leather with a desired moisture level, and allow the leather to have a desired softness. However, the method is limited in that the leather is kept sufficiently moist using only suitable humidification, and is inefficient in that a process of introducing the limestone artificially needs to be further conducted.

Therefore, there exists a demand for further research and development of an artificial leather having a texture and a plurality of physical characteristics which are similar to those of a natural leather to solve problems occurring in the related art including coarse texture, reduced dimensional stability, and fiber pull-out.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a high density artificial leather having an excellent soft texture and a method of manufacturing the same. The high density artificial leather has a texture similar to a natural leather and excellent physical characteristics including flexibility and elasticity by the method which may include shrinking a long fiber-type non-woven fabric with hot water to induce shrinkage; eluting only a sea component polymer fiber from the shrunken non-woven fabric, and impregnating a polymer elastomer in a non-woven fabric free of the sea component polymer fiber to manufacture a high density long fiber-type fine yarn non-woven fabric; and treating a surface of the non-woven fabric, wherein a urethane adhesive layer, a polyurethane skin layer, and a wetting layer are sequentially formed on the surface of the non-woven fabric, and as a result, an appearance of the leather may be improved.

Various aspects of the present invention are directed to providing a method for manufacturing a high density artificial leather having an excellent surface touch.

Various aspects of the present invention are directed to providing an artificial leather manufactured by the provided method.

Various aspects of the present invention are directed to providing a method for manufacturing a high density artificial leather, the method including: (a) manufacturing a long fiber-type non-woven fabric having an areal weight of 400 to 500 g/m² and an apparent density of 0.3 to 0.6 g/cm³ by self-twist spinning a sea component polymer fiber and an island component polymer fiber; (b) shrinking the long fiber-type non-woven fabric with hot water; (c) eluting the sea component polymer fiber from the shrunken non-woven fabric by immersing the shrunken non-woven fabric in an aqueous alkaline solution; and (d) impregnating a polymer elastomer in a non-woven fabric free of the sea component polymer fiber to manufacture a long fiber-type fine yarn non-woven fabric.

Various aspects of the present invention are directed to providing a high density artificial leather manufactured by the provided method.

A method for manufacturing the high density artificial leather according to an exemplary embodiment of the present invention may significantly increase the density of the artificial leather as the hot water shrinkage process is conducted prior to the process of eluting the sea component polymer fiber.

It is also possible to improve an appearance of the leather since physical characteristics including a texture, flexibility, and elasticity of the artificial leather are excellent by forming a polyurethane skin layer and a wetting layer on a fiber base layer including a long fiber-type fine yarn non-woven fabric, and to have the texture similar to that of a natural leather since the texture is excellent.

It is understood that the term “vehicle” or “vehicular” or other similar term as used herein is inclusive of motor vehicles in general including passenger automobiles including sports utility vehicles (SUV), buses, trucks, various commercial vehicles, watercraft including a variety of boats and ships, aircraft, and the like, and may include hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the invention.

### BRIEF DESCRIPTION OF THE DRAWINGS

FIG. 1 is a flowchart schematically illustrating a method for manufacturing an artificial leather according to an exemplary embodiment of the present invention;

FIG. 2 is a scanning electron microscope (SEM) photograph illustrating a layer structure of an artificial leather according to an exemplary embodiment of the present invention; and

FIG. 3 is a photograph capturing an automobile internal sheet manufactured by utilizing an artificial leather according to an exemplary embodiment of the present invention.

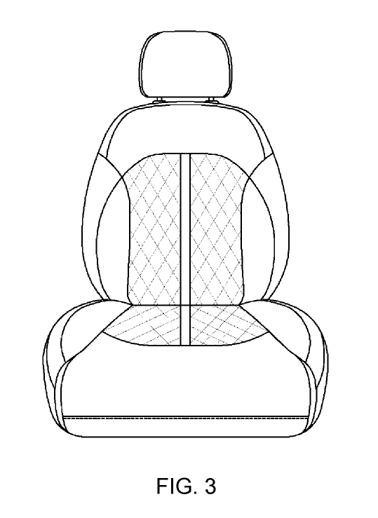

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, the present invention will be described in more detail through an exemplary embodiment.

Various aspects of the present invention are directed to providing a high density artificial leather and a method for manufacturing the same.

A high density artificial leather 200 in an exemplary embodiment of the present invention is manufactured by self-twisting a sea component polymer fiber and an island component polymer fiber to manufacture a long fiber-type non-woven fabric, shrinking the long fiber-type non-woven fabric with hot water, eluting the sea component polymer fiber from the shrunken non-woven fabric, and impregnating a polymer elastomer in a non-woven fabric free of the sea component polymer fiber by elution to manufacture a long fiber-type fine yarn non-woven fabric, and stacking a polyurethane skin layer 202, a urethane adhesive layer 203, and a wetting layer 201 in sequence on a fiber base layer 204 including the non-woven fabric.

A method for manufacturing the high density artificial leather 200 according to an exemplary embodiment of the present invention may significantly increase the density of the artificial leather 200 as the hot water shrinkage process is conducted prior to the process of eluting the sea component polymer fiber.

An appearance of the artificial leather 200 may be improved since a plurality of physical characteristics including a surface touch, a flexibility, and an elasticity of the artificial leather 200 are excellent by forming the polyurethane skin layer 202 and the wetting layer 201 on the fiber base layer 204 including the long fiber-type fine yarn non-woven fabric, and to have a texture similar to that of a texture of a natural leather since the texture is excellent.

According to various aspects of the present invention, a method of manufacturing the high density artificial leather 200 in an exemplary embodiment of the present invention may include (a) manufacturing the long fiber-type non-woven fabric having an areal weight of 400 to 500 g/m² and an apparent density of 0.3 to 0.6 g/cm³ by self-twist spinning the sea component polymer fiber and the island component polymer fiber; (b) shrinking the long fiber-type non-woven fabric with hot water; (c) eluting the sea component polymer fiber from the non-woven fabric by immersing the shrunken non-woven fabric in an aqueous alkaline solution; and (d) impregnating the polymer elastomer in the non-woven fabric free of the sea component polymer fiber by elution to manufacture the long fiber-type fine yarn non-woven fabric.

The method may further include after impregnating (d), (e) manufacturing a first sheet including the fiber base layer 204 including the high density long fiber-type fine yarn non-woven fabric; (f) forming the polyurethane skin layer 202 by coating a polyurethane composition on a release paper; (g) manufacturing a second sheet by forming the urethane adhesive layer 203 on the skin layer 202; (h) laminating the first sheet and the second sheet, and then peeling off the release paper; and (i) forming the wetting layer 201 by coating a wetting composition on the polyurethane skin layer 202 (g), the wetting composition including a polyurethane resin, a wetting agent, a gloss adjusting agent, a plurality of urethane beads, and a solvent.

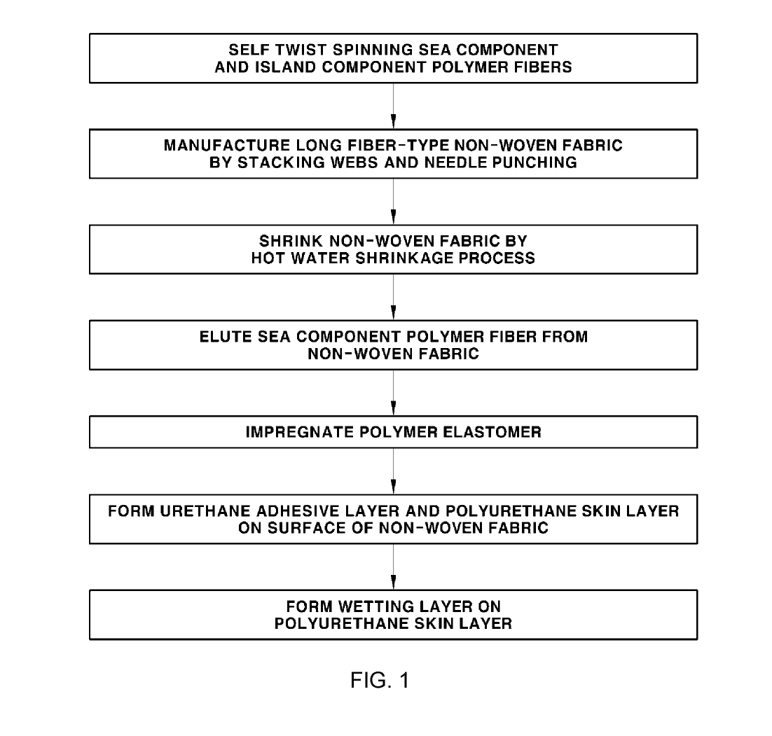

FIG. 1 is a flowchart schematically illustrating a method of manufacturing the artificial leather 200 of the present invention.

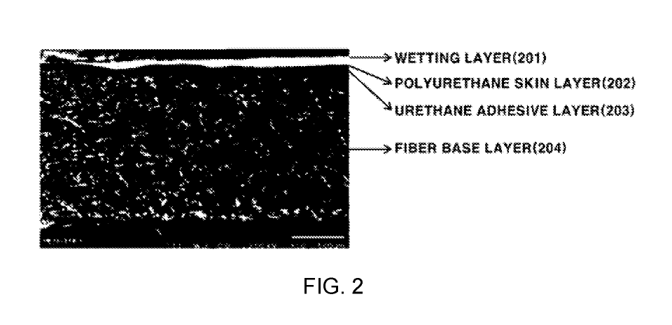

FIG. 2 is a scanning electron microscope (SEM) photograph illustrating a layer structure of the artificial leather 200 according to an exemplary embodiment of the present invention. As illustrated in FIG. 2, the artificial leather 200 in an exemplary embodiment of the present invention has a structure in which the fiber base layer 204 including the high density long fiber-type fine yarn non-woven fabric, the urethane adhesive layer 203, the polyurethane skin layer 202, and the wetting layer 201 are sequentially stacked.

The method of manufacturing the high density artificial leather 200 according to an exemplary embodiment of the present invention is subjected to manufacturing (a) to forming (i) as described above. Hereinafter, each step of the method will be described in detail.

(a): Manufacturing of the Long Fiber-Type Non-Woven Fabric

First, the long fiber-type non-woven fabric is manufactured by self-twist spinning the sea component polymer fiber and the island component polymer fiber. The manufactured long fiber non-woven fabric may have the areal weight of 400 to 500 g/m² and the apparent density of 0.3 to 0.6 g/cm³.

The sea component polymer fiber is a component configured to be eluted while being dissolved in the alkaline solvent, and it may select and use a polymer fiber having a molecular weight, a melt viscosity, and a surface tension which are less than those of the island component polymer fiber under the spinning conditions. As the sea component polymer fiber, it is possible to use one or more selected from a group consisting of co-polyethylene terephthalate (co-PET), polystyrene, polyvinyl alcohol, polypropylene, and polyethylene polymer fibers.

As the island component polymer fiber, it is preferred to adopt a polymer fiber having characteristics in which the polymer fiber is not dissolved in the alkaline solvent, and configured to be easily shrunken during the shrinkage process which is a post process. The polymer fiber may include polyethylene terephthalate (PET), polybutylene terephthalate (PBT), polytrimethylene terephthalate (PTT), polyamide (PA), and the like, which have a high molecular weight.

The sea component polymer fiber and the island component polymer fiber may be mixed at a weight ratio of 25 to 60:40 to 75 during the self-twist spinning. In the present case, when the ratio of the sea component polymer fiber in the overall sea island-type polymer fiber is less than 25 wt %, the ratio is not preferred because it is difficult to achieve a softness and a high sensitivity similar to a natural leather. Furthermore, when the ratio is more than 60 wt %, there occurs a problem in that the quality stability deteriorates because a shape or distribution state of the island component polymer fiber becomes unstable in a cross section of the sea island-type polymer fiber. In addition, as the sea component and island component polymer fibers, the sea component and island component polymer fibers may each have a fineness of 1 to 5 denier may be used.

When the sea component and island component polymer fibers are spun together into the non-woven fabric, a spinneret may be used. As the spinneret, it is possible to use a spinneret in which a plurality of nozzle holes having a plurality of island component polymer fiber channels disposed, within a range of 6 to 150 ea. with respect to one nozzle hole, and a plurality of sea component polymer fiber channels disposed to surround the island component polymer fiber channels is arranged and disposed in a line or circular shape. A long fiber web may be formed by introducing the molten sea component and island component polymer fibers into the spinneret, and then continuously discharging the fibers, and cooling and solidifying the fibers.

A non-woven fabric may be manufactured by conducting a process of stacking several sheets of webs by a cross lapping process of a sea island-type fiber manufactured using the sea component and island component polymer fibers, and a needle-punching process of needle punching the stacked webs.

(b): Subjecting the Long Fiber-Type Non-Woven Fabric to Hot Water Shrinkage

The non-woven fabric is shrunken by the hot water before the sea component polymer fiber is eluted therefrom. When the hot water shrinkage process is conducted in the provided manner, the density of the long fiber-type non-woven fabric may be improved. Due to the above improvement, a final product of the fiber base density of the artificial leather 200 is improved, improving a voluminous feel and a touch of the artificial leather 200. Therefore, the artificial leather 200 manufactured in an exemplary embodiment of the present invention may have an effect of having a high sensitivity similar to that of a natural leather due to an improvement in the sensitivity quality.

When shrinkage (b) is conducted, the hot water shrinkage may be a heat treatment conducted under conditions of a relative humidity (RH) of 70 to 90% and a temperature of 60 to 90° C. In the present case, when the hot water shrinkage is conducted at the relative humidity of 70 to 90%, sufficient shrinkage may be achieved because the sea component polymer fiber may be prevented from curing due to an imparted moisture. Furthermore, when the hot water shrinkage is conducted at the heat treatment temperature within a range of 60 to 90° C., it is possible to have the long fiber-type non-woven fabric sufficiently shrunk, and as a result, the density is increased as compared to that of a conventional non-woven fabric. In an exemplary embodiment of the present invention, examples of a method for maintaining a relative humidity of 70 to 90% includes a method for administering water on a non-woven fabric, a method for imparting water drops under water vapor or mist conditions, and the like.

In shrinkage (b), the non-woven fabric may have an areal weight shrinkage of 10 to 40%. When the areal weight shrinkage is less than 10%, it may not be expected that the density of the non-woven fabric is improved, and when the areal weight shrinkage is more than 40%, the non-woven fabric is shrunken so much that it is difficult to properly implement the form, and elasticity and soft touch may not be implemented. Therefore, in shrinkage (b), when the areal weight shrinkage is 10 to 40%, the density of the non-woven fabric is improved, and as a result, the form retention is improved, and an elasticity and softness which are similar to those of a natural leather may be achieved. The non-woven fabric may have an areal weight shrinkage of 10 to 30%.

(c): Eluting of the Sea Component Polymer Fiber from the Non-Woven Fabric

To form the fine yarn non-woven fabric, it is possible to selectively elute the sea component polymer fiber from the non-woven fabric having an improved density by the hot water shrinkage process of shrinkage (b). In eluting (c), the sea component polymer fiber may be eluted from the shrunken non-woven fabric using an aqueous alkaline solution, but the provided elution method is not limited thereto. The shrunken non-woven fabric is immersed in the aqueous alkaline solution, and as a result of the immersion, a fine yarn non-woven fabric may be formed with eluting the sea component polymer fiber eluted.

(d): Impregnating the Polymer Elastomer in the Non-Woven Fabric to Manufacture the Long Fiber-Type Fine Yarn Non-Woven Fabric

To impart the form stability to the non-woven fabric, a non-woven fabric free of the sea component polymer fiber by elution through eluting (c) may be subjected to an impregnation treatment with a polymer elastomer solution. The impregnation treatment process in impregnating (d) may be conducted as a process of impregnating the non-woven fabric in a solution in which a polymer elastomer is dissolved in a solvent including dimethylformamide (DMF), and then solidifying the non-woven fabric.

In the present case, the solution in which the polymer elastomer is dissolved may be a solution in which 30 to 40 parts by weight of an organic solvent, 0.1 to 1 parts by weight of a surfactant, and 5 to 15 parts by weight of a toner are mixed in 100 parts by weight of the polymer elastomer. As a material for the polymer elastomer, a material which is a polyurethane resin having a weight average molecular weight (Mw) of 70,000 to 120,000 may be used. Polyurethane impregnated in the non-woven fabric may be fixed by dipping the non-woven fabric in a solution in which the polyurethane resin is dissolved, and then solidifying the non-woven fabric in an aqueous dimethylformamide (DMF) solution.

The polymer elastomer impregnated in the non-woven fabric is present in an amount of 15 to 40 wt %, based on the total weight of the non-woven fabric. When the content of the polymer elastomer is within the provided range, it is possible to have an effect of increased the density of a product of the artificial leather 200 and increasing the elasticity and stretchability thereof while the polymer elastomer is inserted into a plurality of pores produced by the process of eluting the sea component polymer fiber. Therefore, when the content of the impregnated polymer elastomer is less than 15 wt %, the density of the non-woven fabric may not be increased, and the elasticity and stretchability may not be as desired. In contrast, when the content of the impregnated polymer elastomer is more than 40 wt %, there is a problem that the flexibility and sensitive qualities deteriorate, and the polymer elastomer may be impregnated within the aforementioned range, accordingly.

(e): Manufacturing of the First Sheet

To form the polyurethane skin layer 202 on the other surface of the high density long fiber-type fine yarn non-woven fabric manufactured in impregnating (d), a solution including the polyurethane resin may be coated on a release paper having various patterns formed thereon, and the polyurethane skin layer 202 may be bonded to the release paper by an adhesive. Furthermore, in a method of bonding the polyurethane skin layer 202 in a form of a film, and the like, the polyurethane skin layer 202 may be formed by adopting any of the generally known methods.

To conduct the method of coating the solution on the release paper and bonding the polyurethane skin layer by the adhesive, the method may be conducted by each of the following steps.

After impregnating (d), it is possible to manufacture a first sheet including the fiber base layer 204 including the high density long fiber-type fine yarn non-woven fabric in manufacturing (e).

(f): Forming of the Polyurethane Skin Layer 202

The polyurethane skin layer 202 may be formed by coating a polyurethane composition on a release paper. In the present case, the polyurethane composition may include 15 to 50 parts by weight of a solvent and 10 to 20 parts by weight of a toner in 100 parts by weight of a polyurethane resin for forming the skin layer. As the polyurethane resin, a polyurethane resin manufactured by mixing a carbonate polyol having a weight average molecular weight of 30,000 to 70,000 may be used.

In the present case, as the release paper, a paper or a film material may be used, and, the paper or the film material has a constant thickness and a high dimensional stability, and thus is not deformed by heat and pressure.

The polyurethane skin layer 202 formed in forming (f) may have a thickness of 70 to 100 μm. In the present case, when the thickness is less than 70 μm, the physical characteristics including wear resistance and scratch resistance deteriorate and it is difficult to implement a color, and when the thickness is more than 100 μm, there may occur a problem in surface bubbles are poor and the productivity deteriorates. Therefore, when the polyurethane skin layer 202 is formed to have a thickness within a range of 70 to 100 μm, the polyurethane skin layer 202 may have a soft texture and appearance similar to those of a natural leather as a surface layer is formed within the range.

(g): Manufacturing of the Second Sheet

A second sheet may be manufactured by forming the urethane adhesive layer 203 on the skin layer. As an adhesive used as the urethane adhesive layer 203, a general adhesive used in the art may be used, and the adhesive is not particularly limited. A urethane-based adhesive, and more preferably a polycarbonate-based urethane adhesive may be used. In the present manner, the second sheet may be manufactured to have a structure in which the polyurethane skin layer 202 and the urethane adhesive layer 203 are sequentially stacked on a release paper.

(h): Laminating of the First Sheet and Second Sheet

The first sheet and the second sheet are laminated, and then the release paper may be peeled off.

That is, the second sheet on which the urethane adhesive layer 203 is stacked is laminated on the first sheet including the fiber base layer 204 including the long fiber-type fine yarn non-woven fabric, and then the release paper is peeled off.

(i): Forming of the Wetting Layer 201

To increase a degree of gloss of the surface of the artificial leather 200 in which the first and second sheets are laminated, a surface treatment process may be conducted with a wetting composition. The artificial leather 200 may be manufactured by coating a wetting composition on the polyurethane skin layer 202 from which the release paper is peeled off in manufacturing (g), to form the wetting layer 201, the wetting composition including a polyurethane resin, a wetting agent, a gloss adjusting agent, a plurality of urethane beads, and a solvent. As the wetting agent, it is possible to use one or more selected from a group consisting of sodium dodecylbenzene sulfonate, sodium dibutyl naphthalene sulfonate, sodium diisopropyl naphthalene sulfonate, and sodium dioctyl sulfosuccinate.

A material which forms the wetting layer 201 may be a material having a resistance to degradation while the wettability is maintained even after repeated washing and drying processes. A particulate powder material having a particle diameter of 1 to 10 μm manufactured by mixing the wetting agent with the polyurethane resin, and then milling the resulting resin may be used. In the case, when the particle diameter is more than 10 μm, there is a problem that the surface of the artificial leather 200 is stretched and it is difficult to form a uniform wetting layer 201.

As the wetting layer 201 is formed on the surface of the polyurethane skin layer 202 in the provided manner, immediate wetting characteristics may be obtained, and as a result, the surface of a product of the artificial leather 200, which is a final product, becomes wet, and thus has a soft texture, and the degree of gloss may be improved. Furthermore, the artificial leather 200 manufactured by the aforementioned method may have an apparent density of 0.7 to 0.9 g/cm³.

Hereinafter, the present invention will be described in more detail with reference to the Examples, and the present invention is not limited by the following Examples.

### EXAMPLES

The following examples illustrate the invention and are not intended to the limit the same.

### Preparation Example 1

### Manufacture of a High Density Non-Woven Fabric

30 wt % of co-polyethylene terephthalate (co-PET) as the sea component polymer fiber having an average fineness of 2.8 denier and 70 wt % of polyethylene terephthalate (PET) as an island component polymer fiber having an average fineness of 2.8 denier were discharged while adjusting a spinning speed to approximately 4,000 m/min. Next, a long fiber web having an average weight per unit area of 30 to 35 g/m² was formed by a spun bond process.

A stacked web of sea island-type composite long fibers was manufactured by subjecting the long fiber web to a lapping process using a cross-lapper device, and then a non-woven fabric having an average areal weight of 450 g/m², an apparent density of 0.360 g/cm³, and an average thickness of 1.25 mm was manufactured by conducting a needle punching process on the stacked web.

After the manufactured non-woven fabric was shrunken by hot water at 80° C. for 3 minutes, a shrunken non-woven fabric having a density of 0.43 g/cm³ was obtained by setting the moisture content to 50% or less based on the weight of the non-woven fabric, and hot-wind drying the non-woven fabric at 110° C. for 10 minutes. In the present case, an areal shrinkage caused by the shrinkage in the longitudinal and transverse directions was shrunken by 28%.

The weight of the shrunken non-woven fabric was decreased in an aqueous NaOH solution having a concentration of 3 wt % for 30 minutes, and a high density fine yarn non-woven fabric having a density of 0.41 g/cm³ was manufactured by elution of the sea component polymer fiber.

Next, the fine yarn non-woven fabric from which the sea component polymer fiber was eluted was immersed in a urethane impregnation solution including a urethane resin for impregnation, dimethylformamide, a surfactant, and a toner for adjusting a color at a ratio of 100:35:0.5:10 parts by weight, the non-woven fabric was solidified in a 10% aqueous DMF solution, and then washed with water and dried, obtaining a high density urethane impregnated long fiber fine yarn non-woven fabric.

The following Table 1 shows a comparison of weights, thicknesses and densities of the fine yarn non-woven fabric before and after the shrinkage and after the decrease in weight.

TABLE 1

| | Shrinkage | | After decrease in |
|---|---|---|---|
| Parameter | Before | After | weight |
| Areal weight | 450 | 530 | 451 |
| (g/m²) | | | |
| Thickness (mm) | 1.25 | 1.30 | 1.21 |
| Density (g/cm³) | 0.36 | 0.41 | 0.38 |

| | |
|---|---|
| Areal shrinkage (%) | 28% |

As shown in Table 1, the density of the non-woven fabric was increased from 0.36 g/cm³ to 0.41 g/cm³ after the shrinkage treatment. Furthermore, the areal shrinkage caused by the shrinkage in the longitudinal and transverse directions was shrunken by 28%. In addition, after the decrease in weight, the fiber was partially damaged, and as a result, a phenomenon in which the density was reduced to 0.38 g/cm³ was exhibited.

### Example 1

### Manufacture of the High Density Artificial Leather

A composition for the polyurethane skin layer 202 and the urethane adhesive layer 203 of the artificial leather 200 was prepared as follows.

First, a polyurethane composition for the skin coating was prepared by mixing a polyurethane resin for the skin coating, which was synthesized using carbonate diol as a main raw material, dimethylformamide, methyl ethyl ketone, and a toner for adjusting a color at a weight ratio of 100:15:30:15.

The urethane adhesive composition was prepared by mixing a urethane resin for an adhesive including carbonate diol as a main raw material, dimethylformamide, methyl ethyl ketone, and a crosslinking agent at a weight ratio of 100:10:30:13.

Next, the polyurethane skin layer 202 was prepared by coating the polyurethane composition for skin coating to have a thickness of 100 μm onto a release paper having various patterns by a knife coating method, and drying the polyurethane composition. As such, the urethane adhesive layer 203 was formed by coating the urethane adhesive composition to have a thickness of approximately 120 μm onto the surface of the dried polyurethane skin layer 202, and drying the urethane adhesive composition.

Next, the fiber base layer 204 including the high density fine yarn non-woven fabric manufactured in Preparation Example 1 was laminated with the adhesive layer, and the laminate was post-cured for 48 hours while maintaining the temperature at 80° C. Next, the release paper was peeled off, manufacturing a high density artificial leather 200 in which the urethane adhesive layer 203 and the polyurethane skin layer 202 were formed onto the surface of the high density long fiber-type fine yarn non-woven fabric.

### Example 2

### Manufacture of a High Density Artificial Leather

The high density artificial leather 200 was manufactured in the same manner as in Example 1, and then a surface treatment process of forming the wetting layer 201 was conducted using a wetting composition on the artificial leather 200.

In the present case, for the wetting composition used to subject the surface of the high density artificial leather 200 to the surface treatment, 15 parts by weight of sodium dodecyl benzene sulfonate particles (Solvay-Rhodia Rhodacal, DS-10) were mixed with 100 parts by weight of a sulfur-free deformed urethane resin for the skin, and then the resulting mixture was milled and micronized to a particle size of 5 μm, preparing a wetting agent.

The viscosity was adjusted to 100 cps (25° C.) by mixing 50 parts by weight of dimethylformamide and 30 parts by weight of methyl ethyl ketone with 100 parts by weight of the micronized wetting agent, and then 0.8 parts by weight of silica being a gloss adjusting agent and 1.0 parts by weight of urethane beads were mixed, preparing a wetting composition.

Next, the wetting layer 201 was formed by coating the wetting composition onto the surface of the artificial leather 200 manufactured in Example 1 by a gravure coating method.

### Test Examples

### Comparative Preparation Example 1

### Manufacture of a High Density Non-Woven Fabric

A raw fabric of 380 g/m² was manufactured using 50 wt % of a polyester having a fineness of 1.4 denier and a fiber length of 51 mm and 50 wt % of Nylon having a fineness of 2 denier and a fiber length of 51 mm by a typical method for manufacturing a needle punching non-woven fabric, the raw fabric was shrunk, and then the weight was decreased in a 3% aqueous NaOH solution for 30 minutes, and the results are shown in the following Table 2.

TABLE 2

| | Shrinkage | | After decrease in |
|---|---|---|---|
| Parameter | Before | After | weight |
| Weight (g/m²) | 380 | 430 | 350 |
| Thickness (mm) | 1.35 | 1.37 | 1.25 |
| Density (g/cm³) | 0.25 | 0.31 | 0.28 |

| | |
|---|---|
| Areal shrinkage (%) | 32% |

As shown in Table 2, the density of the non-woven fabric was increased from 0.25 g/cm³ to 0.31 g/cm³ after the shrinkage treatment. In addition, after the decrease in weight, the non-woven fabric fiber was partially damaged, and as a result, it was confirmed that a phenomenon in which the density was reduced to 0.28 g/cm³ was exhibited. Through the above, it was confirmed that even though the density was increased due to the shrinkage, it was difficult to exhibit a density of 0.3 g/cm³ or more after the decrease in weight.

### Comparative Preparation Example 2

### Manufacture of a High Density Non-Woven Fabric

After a non-woven fabric was manufactured using the same constituent components as in Preparation Example 1, the non-woven fabric was shrunk by being treated with hot water at 80° C. for 3 minutes, and then cold impregnated with polyurethane at 35° C. for 10 minutes. Next, a sea component polymer fiber was eluted in the same manner as in Preparation Example 1, immersed in a urethane impregnation solution, and then washed with water and dried, manufacturing a high density urethane impregnated long fiber fine yarn non-woven fabric.

The following Table 3 shows a comparison of weights, thicknesses and densities of the manufactured non-woven fabric before and after the shrinkage and after the decrease in weight.

TABLE 3

| | Shrinkage | | After being cold | After decrease |
|---|---|---|---|---|
| Parameter | Before | After | impregnated | in weight |
| Areal weight (g/m²) | 380 | 430 | 480 | 405 |
| Thickness (mm) | 1.35 | 1.37 | 1.38 | 1.30 |
| Density (g/cm³) | 0.28 | 0.31 | 0.34 | 0.31 |

| | |
|---|---|
| Areal shrinkage (%) | 29% |

As shown in Table 3, the density of the non-woven fabric was increased from 0.28 g/cm³ to 0.31 g/cm³ after the shrinkage treatment. In addition, after the decrease in weight, the non-woven fabric fiber was partially damaged, and as a result, it was confirmed that a phenomenon in which the density was reduced to 0.31 g/cm³ was exhibited.

Through the above, it was confirmed that when the non-woven fabric was cold impregnated with polyurethane after being shrunken in hot water, the sensitivity quality deteriorated due to the occurrence of a phenomenon in which the aqueous polyurethane dispersion was focused on the surface of the product during the heat drying process. Furthermore, it was confirmed that as the amount of aqueous polyurethane dispersion impregnated was increased, the surface of the product was hardened.

### Comparative Example 1

### Manufacture of Artificial Leather

Artificial leather was manufactured in the same manner as in Example 1, except that the high density non-woven fabric manufactured in Comparative Preparation Example 1 was used.

### Comparative Example 2

### Manufacture of Artificial Leather

Artificial leather was manufactured in the same manner as in Example 1, except that the high density non-woven fabric manufactured in Comparative Preparation Example 2 was used.

Physical characteristics of the artificial leather manufactured in Examples 1 and 2 and Comparative Examples 1 and 2 were measured by the following evaluation methods, and the results are shown in Table 4.

<Evaluation Method>

Apparent Density

Each unit weight and thickness of the artificial leather in Examples 1 and 2 and Comparative Examples 1 and 2 according to an exemplary embodiment of the present invention was measured. In the present case, the unit weight was determined by the method in accordance with JIS L 1096 8. 4. 2, and the thickness was determined by a gauge (Ozaki MFG. Co., Ltd., PeacockH).

Thereafter, an apparent density was determined from each unit weight value and thickness measurement value of the artificial leather 200.

Constant Load Elongation

A test specimen having a width of 50 mm and a length of 250 mm was cut into 5 pieces, and the constant load elongation was evaluated by a test method in accordance with the MS-321-07. When the constant load elongation was small, the elasticity was insufficient wherein the number of stitch holes for sewing was increased, cured portion wrinkles occurred, and the form stability deteriorated when used for a long time period.

Stiffness

The stiffness was evaluated by a test method in accordance with the MS-300-31. The stiffness means a resistance to bending deformation of a raw fabric, and the test is a test of evaluating flexibility, and the like.

A test specimen having a width of 25 mm and a length of 200 mm was placed on a test stand having an inclination surface of 45°, the test specimen was pressed down with a pressure plate having the same size as that of the test specimen, and was slid down at a speed of approximately 10 mm/sec in the inclination surface direction, and when a first end portion of the test specimen was brought into contact with the inclination surface, a position at a second end portion was read. The stiffness was expressed as a moving distance (mm), all the five test specimens were determined transversely and longitudinally, and the average value thereof was exhibited. A smaller value means being soft.

Flexibility (Softness) Sensitivity

The flexibility (softness) was evaluated by a test method in accordance with the ISO 17235.

Surface Touch

A sensory evaluation on the items including the degree of moisture and softness was conducted. For the sensory evaluation, the evaluation was conducted by six experts on artificial leather.

The artificial leather manufactured in Examples 1 and 2 and Comparative Examples 1 and 2 were evaluated by use of the evaluation methods, and the results are shown in the following Table 4.

TABLE 4

| | | Constant load | | | | | |
|---|---|---|---|---|---|---|---|
| | | elongation (%) | | Stiffness | | | |
| | Density | Length | Width | Length | Width | Flexibility | Surface |
| Classification | (g/cm³) | (%) | (%) | (mm) | (mm) | (mm) | touch |
| Example 1 | 0.79 | 13 | 31 | 116 | 96 | 3.5 | ⊚ |
| Example 2 | 0.81 | 13 | 32 | 116 | 95 | 3.6 | ⊚ |
| Comparative | 0.66 | 15 | 40 | 146 | 132 | 2.8 | ◯ |
| Example 1 | | | | | | | |
| Comparative | 0.69 | 10 | 27 | 165 | 150 | 2.6 | Δ |
| Example 2 | | | | | | | |

Δ ≡ After a product is manufactured, the surface touch including moisture is normal
◯ ≡ After a product is manufactured, the surface touch including moisture is good
⊚ ≡ After a product is manufactured, the surface touch including moisture is excellent

As shown in Table 4, when the artificial leather 200 in Examples 1 and 2 was compared with those in Comparative Examples 1 and 2, the densities were increased. Furthermore, it may be confirmed that in the case of Example 2 in which the wetting layer 201 was formed on the surface of the artificial leather 200, the surface touch was best because the moisture on the surface was increased.

It was also confirmed that the artificial leather 200 manufactured in Examples 1 and 2 of the present invention exhibited all the excellent characteristics in terms of constant load elongation, stiffness, flexibility, and the like, as compared to Comparative Examples 1 and 2, and a tendency similar to the texture of a natural leather was exhibited due to the excellent surface touch.

For convenience in explanation and accurate definition in the appended claims, the terms “upper”, “lower”, “up”, “down”, “upwards”, “downwards”, “internal”, “outer”, “inside”, “outside”, “inwardly”, “outwardly”, “internal”, “external”, “front”, “rear”, “back”, “forwards”, and “backwards” are used to describe features of the exemplary

The foregoing description of specific exemplary embodiments of the present invention has been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the present invention and their practical application, to enable skilled in the art to make and utilize various exemplary embodiments of the present invention, as well as various alternatives and modifications thereof. It is intended that the scope of is the invention be defined by the Claims appended hereto and their equivalents.

What is claimed is:

1. A method for manufacturing a high density artificial leather, the method comprising:
(a) manufacturing a long fiber-type non-woven fabric having an areal weight of 400 to 500 g/m² and an apparent density of 0.3 to 0.6 g/cm³ by self-twist spinning a sea component polymer fiber and an island component polymer fiber;
(b) shrinking the long fiber-type non-woven fabric with hot water;
(c) eluting the sea component polymer fiber from the shrunken non-woven fabric by immersing the shrunken non-woven fabric in an aqueous alkaline solution; and
(d) impregnating a polymer elastomer in a non-woven fabric from which the sea component polymer fiber is eluted, to manufacture a long fiber-type fine yarn non-woven fabric.

2. The method of claim 1, wherein in the manufacturing (a), a mixing ratio of the sea component polymer fiber and the island component polymer fiber is a weight ratio of 25 to 60:40 to 75, and each of the sea component and island component polymer fibers has a fineness of 1 to 5 denier.

3. The method of claim 1, wherein in the manufacturing (a), the sea component polymer fiber is one or more selected from a group consisting of co-polyethylene terephthalate (co-PET), polystyrene, polyvinyl alcohol, polypropylene, and polyethylene polymer fibers, and the island component polymer fiber is one or more selected from a group consisting of polyethylene terephthalate (PET), polybutylene terephthalate (PBT), polytrimethylene terephthalate (PTT), and polyamide (PA).

4. The method of claim 1, wherein the shrinking (b) includes a heat treatment conducted at a relative humidity (RH) of 70 to 90% and a temperature of 60 to 90° C.

5. The method of claim 1, wherein the shrinking (b) includes a shrinkage rate of the areal weight of the non-woven fabric achieves 10 to 40%.

6. The method of claim 1, wherein in the impregnating (d), the polymer elastomer is a polyurethane resin having a weight-average molecular weight of 70,000 to 120,000.

7. The method of claim 1, wherein in the impregnating (d), the polymer elastomer impregnated in the non-woven fabric is in an amount of 15 to 40% by weight, based on a total weight of the non-woven fabric.

8. The method of claim 1, further including:
after the impregnating (d),
(e) manufacturing a first sheet including a fiber base layer including the long fiber-type fine yarn non-woven fabric;
(f) forming a polyurethane skin layer by coating a polyurethane composition on a release paper;
(g) manufacturing a second sheet by forming a urethane adhesive layer on the skin layer;
(h) laminating the first sheet and the second sheet, and then peeling off the release paper; and
(i) forming a wetting layer by coating a wetting composition on the polyurethane skin layer of the manufacturing (g), the wetting composition including a polyurethane resin, a wetting agent, a gloss adjusting agent, urethane beads, and a solvent.

9. The method of claim 8, wherein the forming (f) includes the polyurethane skin layer having a thickness of 70 to 100 μm.

10. The method of claim 8, wherein in the forming (i), the wetting agent is one or more selected from a group consisting of sodium dodecylbenzene sulfonate, sodium dibutyl naphthalene sulfonate, sodium diisopropyl naphthalene sulfonate, and sodium dioctyl sulfosuccinate.

11. The method of claim 8, wherein the artificial leather has an apparent density of 0.7 to 0.9 g/cm³.

12. The high density artificial leather manufactured by the method of claim 1.
